(19) United States
(12) Patent Application Publication
(10) Pub. No.: US 2017/0068375 A1
(43) Pub. Date: Mar. 9, 2017

(54) CONTROLLING A DEVICE

(71) Applicant: Microsoft Technology Licensing, LLC, Redmond, WA (US)

(72) Inventor: Graham C. Plumb, London (GB)

(21) Appl. No.: 14/849,201

(22) Filed: Sep. 9, 2015

(51) Int. Cl. G06F 3/041; G06F 3/0484

(52) U.S. Cl. CPC G06F 3/0416; G06F 3/04842

(57) ABSTRACT

A display device is useable by multiple users simultaneously. A display of the display device has a total display area. A display element is displayed so that it occupies a first region of the total display area smaller than the total display area. Based on a determined location of the first region, a second region of the total display area is defined that surrounds the first region, and that is smaller than the total display area. Whilst the display element is being displayed on the display, receiving from one of the users of the media device via an input device of the media device a selection of a point on the display. If the point on the display selected by the user is outside of the first region but within the second region, the display is controlled to dismiss the display element.

### BACKGROUND

For some time now, mobile devices such as smartphones and tablets have incorporated touchscreen technology. Such devices are small and portable, and as such have relatively small touchscreen displays that are designed to be used by only one user at a time.

Touchscreen technology is now being incorporated into larger display devices designed to be used by multiple users simultaneously. Such devices may incorporate multi-touch technology, whereby separate touch inputs can be applied to a large touchscreen display of the device by different users simultaneously, and separately recognized by the display device. This is designed to encourage multiple participant interaction and facilitate collaborative workflow for example in a video conference call being conducted via a communications network using a large, multi-user display device in a conference room. The touch inputs may for example be applied using a finger or stylus (or one user may be using their finger(s) and another a stylus etc.). An example of such a device is the Surface Hub recently developed by Microsoft.

The operation of such a display device is typically controlled at least in part by software executed on a processor of the display device. The software controls the display of the display device, when execute, to provide a graphical user interface (GUI) to the users. The large size and multi-user functionality of the device on which the code is to be executed means that a programmer is faced with a particular set of challenges when optimizing the behaviour of the GUI—very different from those presented when building a GUI for a smaller touchscreen device such as a smartphone or tablet.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A display device is useable by multiple users simultaneously. A display of the display device has a total display area. The display is controlled to display a display element so that the display element occupies a first region of the total display area smaller than the total display area. A location of the first region of the total display area is determined. Based on the determined location of the first region, dismiss zone data is generated so as to define a second region of the total display area is defined that surrounds the first region, and that is smaller than the total display area. Whilst the display element is being displayed on the display, receiving from one of the users of the media device via an input device of the media device a selection of a point on the display. If the point on the display selected by the user is outside of the first region but within the second region, the display is controlled to dismiss the display element.

### BRIEF DESCRIPTION OF FIGURES

FIG. 1 shows a display device being used by multiple users simultaneously;

FIG. 2 shows a block diagram of the display device;

FIG. 3A shows how a total display area of the display device may be divided into zones;

FIGS. 3B-3C show how the zones may be used to define a dismiss zone for a menu displayed by the display device;

FIG. 4 shows a flow chart for a method implemented by the display device;

FIG. 5 shows an exemplary state of a display of the display device.

### DETAILED DESCRIPTION OF EMBODIMENTS

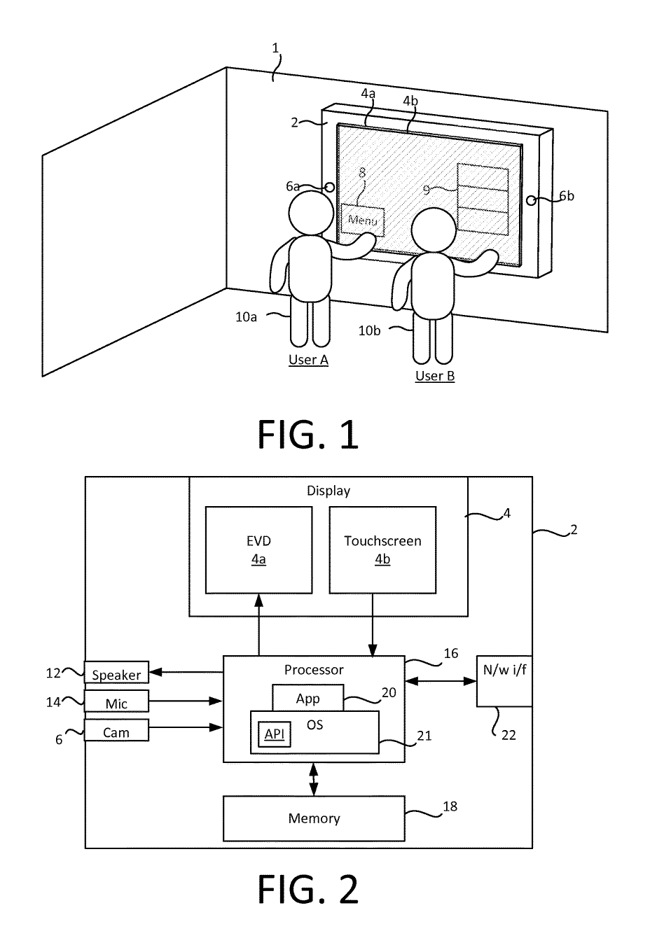

FIG. 1 shows a display device 2 installed in an environment 1, such as a conference room. The display device 2 is show mounted on a wall of the conference room 1 in FIG. 1, and first and second users 10a (“User A”), 10b (“User B”) are shown using the display device 2 simultaneously.

The display device 2 comprises a display 4 formed of a display screen 4a and a transparent touchscreen 4b overlaid on the display screen 4a. The display screen 4a is formed of a 2×2 array of pixels having controllable illumination. The array of pixels spans an area (“total display area”), in which images can be displayed by controlling the luminance and/or chrominance of the light emitted by the pixels. The touchscreen 4b covers the display screen 4a so that each point on the touchscreen 4a corresponds to a point within the total display area.

The display device 2 also comprises one or more cameras 6—first and second cameras 6a, 6b in this example—that are located near the left and right hand sides of the display device 2 respectively, close to the display 4.

FIG. 2 shows a highly schematic block diagram of the display device 2. As shown, the display device 2 is a computer device that comprises a processor 16 and the following components connected to the processor 16: the display 4, the cameras 6, one or more loudspeakers 12, one or more microphones 14, a network interface, and a memory 18. These components are integrated in the display device 2 in this example. In alternative display devices that are within the scope of the present disclosure, one or more of these component may be external devices connected to the display device via suitable external output(s).

The display screen 4a of the display 4 and speakers(s) 12 are output devices controllable by the processor 16 to provide visual and audible outputs respectively to the users 10a, 10b.

The touchscreen 4b is an input device of the display device 2; it is multi-touch in the sense that it can receive and distinguish multiple touch inputs from different users 10a, 10b simultaneously. When a touch input is received at a point on the touchscreen 4a (by applying a suitable pressure to that point), the touchscreen 4a communicates the location of that point to the processor 20. The touch input may be provided, for example, using a finger or stylus, typically a device resembling a conventional pen.

The microphone 14 and camera 6 are also input devices of the display device 2, controllable by the code 20 when executed to capture audio and moving images (i.e. video, formed of a temporal sequence of frames successively captured by the camera 6) of the users 10a, 10b respectively as the user the display device 2.

Other display devices may comprise alternative or additional input devices, such as a conventional point-and-click or rollerball mouse, or trackpad.

An input device(s) may be configured to provide a “natural” user interface (NUI). An NUI enables the user to interact with a device in a natural manner, free from artificial constraints imposed by certain input devices such as mice, keyboards, remote controls, and the like. Examples of NUI methods include those utilizing touch sensitive displays, voice and speech recognition, intention and goal understanding, motion gesture detection using depth cameras (such as stereoscopic or time-of-flight camera systems, infrared camera systems, RGB camera systems and combinations of these), motion gesture detection using accelerometers/gyroscopes, facial recognition, 3D displays, head, eye, and gaze tracking, immersive augmented reality and virtual reality systems etc.

The memory 18 holds code that the processor is configured to execute. The code includes a software application. An instance 20 of the software application is shown running on top of an operating system (“OS”) 21. For example, the OS 21 may be the Windows 10 operating system released by Microsoft. The Windows 10 OS is a cross-platform OS, designed to be used across a range of devices of different sizes and configurations, including mobile devices, conventional laptop and desktop computers, and large screen devices such as the Surface Hub.

The code 20 can control the display screen 4a to display one or more display elements, such as a visible menu 8 or other display element(s) 9. In some cases, a display element may be specific to a particular user; for example, the menu 8 may have been invoked by the first user 10a and be intended for that user specifically. The menu 8 comprises one or more options that are selectable by the first user 10a by providing a touch input on the touchscreen 4b within the part of the total display area occupied by the relevant option.

The display device 2 can connect to a communications network of a communications system, e.g. a packet-based network such as the Internet, via the network interface 22. For example, the code 20 may comprise a communication client application (e.g. Skype™ software) for effecting communication events within the communications system via the network, such as a video call, and/or another video based communication event(s) such as a whiteboard or screen sharing session, between the users 10a, 10b and another remote user(s). The communication system may be based on voice or video over internet protocols (VoIP) systems. These systems are beneficial to the user as they are often of significantly lower cost than conventional fixed line or mobile cellular networks, particularly for long-distance communication. The client software 20 sets up the VoIP connections as well as providing other functions such as registration and user authentication based on, say, login credentials such as a username and associated password.

It's a common user interface (UI) pattern to present a menu on a touchscreen that is (for all intents and purposes) modal. This enables the user to touch (or click) an area outside of the menu's immediate bounds in order to dismiss it.

The term “modal” in the present contact refers to a display element displayed by a software application (or, more accurately, a particular instance of the software application), which can be dismissed, i.e. so that it is no longer displayed, by selecting a point outside of the area of the display occupied by the display element. In some though not all cases, other input functions may be ‘locked’ until the modal menu is dismissed to prevent interaction between the user and other display elements. For example, for software built on a windows-based operating system, the main window of the application 20 may be locked until the modal element has been dismissed, preventing a user from continuing workflow of the main window.

For phones and small touchscreens, this is sufficient as there is only ever going to be one user interacting with the device at any given time.

However, for a very large touchscreen, such as an 84″ or other large Surface Hub, this modality can break collaborative flow.

For example, consider the situation shown in FIG. 1, in which the two users 10a, 10b are located to the left and right-hand side of the large display device 2 respectively. Suppose User A 10a is using an instance Skype and attempting to switch cameras—an action invoked by selecting a menu, e.g. flyout menu, and user B is gesticulating during a screen-share, for example using an instance of the Microsoft OneNote application. For a modal flyout menu, User B's touches will unintentionally dismiss the flyout each time User A opens it, effectively creating a race-condition which then interrupts and breaks down the collaboration.

It is convenient for a flyout menu to be modal in the sense described above, as it can be easily dismissal by a user. In order to preserve useful modal behaviour whilst at the same time allowing multiple users to use the display device 2 simultaneously, embodiments of the present disclosure ‘zone’ a touchscreen so that an application can more intelligently determine if a user's touch or mouse-click is contextually relevant to its dismissal.

This can be achieved various ways.

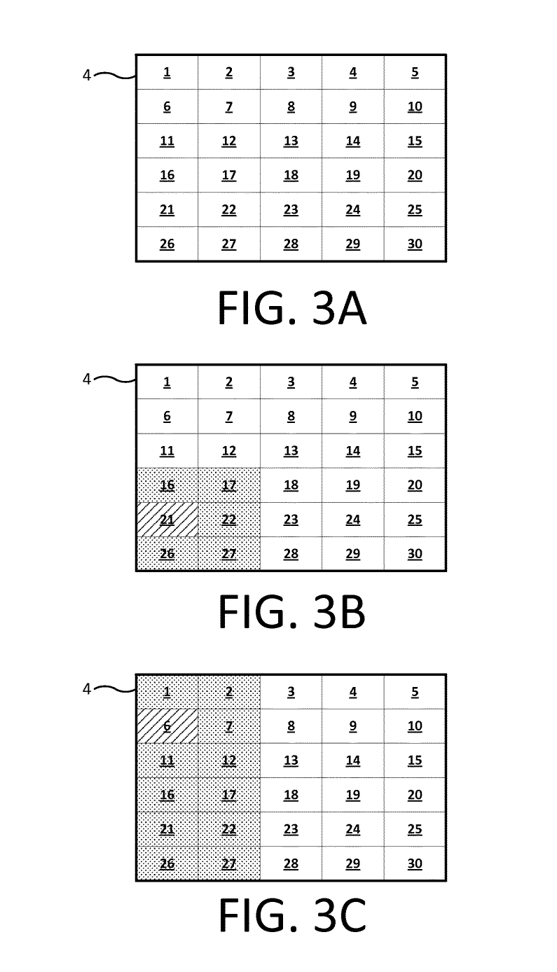

FIGS. 3A-3C illustrates a first mechanism, which is based on heuristics.

As illustrated in FIG. 3A, the total display area of the large touchscreen 4 is divided into a series of spatial zones—labelled “1” to “30” in FIGS. 3A-3C. The zones are rectangular in shape, have uniform sizes and are distributed in a table-like arrangement. The zones are defined by the software application 20 or the OS 21 (or a combination of both pieces of software) generating zoning data which defines the zone boundaries. The arrangement of zones varies in dependence on screen size, pixel density and/or touch resolution, and the zoning data is generated based on one or more of these as appropriate. For examples, in some embodiments at least one (e.g. each) of the zones has a size that is dependent on one or more of these factors and/or the number of zones depends on one or more of these factors. E.g. a greater number of zones may be defined for a larger, higher resolution display, and smaller zones may be defines for a touchscreen having a greater touch resolution.

As illustrated in FIG. 3B, when the application 20 presents a flyout menu in, say, zone 21 (denoted by hatched shading) it also generates dismiss zone data that defines a dismiss zone (denoted by dotted shading) surrounding the menu zone 21. The dismiss zone is smaller than the total display area i.e. it has a smaller area as measured in units of pixels i.e. is it a strict sub-region of the total display area.

FIG. 3B illustrates a first example, in which the dismiss zone is formed of a contagious set of zones, specifically all of the zones immediately adjacent the menu zone 21 (vertically, horizontally and diagonally adjacent), and only those zones—zones 16, 17, 22, 26 and 27 in this example. In the first example, the menu would only be dismissed by touches/clicks in zones 16, 17, 22, 26 and 27 (in contrast to existing GUI menus, which would be dismissible in any zone outside of the menu's bounds).

As illustrated in FIG. 3C, for zones at the top of the screen (for example, when a flyout is presented in zone 6 as illustrated), the dismiss zone may be extruded vertically since it is unlikely a person will physically lean through another to touch a zone towards the bottom of the screen. That is, in some cases e.g. when the menu is presented near the top of the display 4, the dismiss zone may occupy the entire height of the total display area.

It will be appreciated that this is just one example for the purposes of illustration. For example, the menu may span multiple zones, and/or there may be a lesser or greater number of zones in total.

A second mechanism, based on skeletal tracking, may be used in addition to the first mechanism.

As mentioned, the display device 2 has two cameras 6a, 6b located to the left and right of the device 2 respectively. For example, the Surface Hub comes equipped with cameras on the left-hand and right-hand bezel of the device. Additional (optional) cameras may also be mounted along the top-edge of the device.

Using these cameras, it is possible to track multiple skeletons to a high level of fidelity, incorporating depth and digit tracking. For example, the Microsoft® Kinect APIs can be utilized to this end (see for example https://msdn.microsoft.com/en-us/library/hh973074.aspx). Thus, in this example, it is possible to detect that there are two separate skeletons, i.e. those of the users 10a, 10b who are using the display device 4, and identify and track them separately. An identifier is generated in the memory 16 and associated with each discernible skeleton that is currently detectable by the skeleton tracking software.

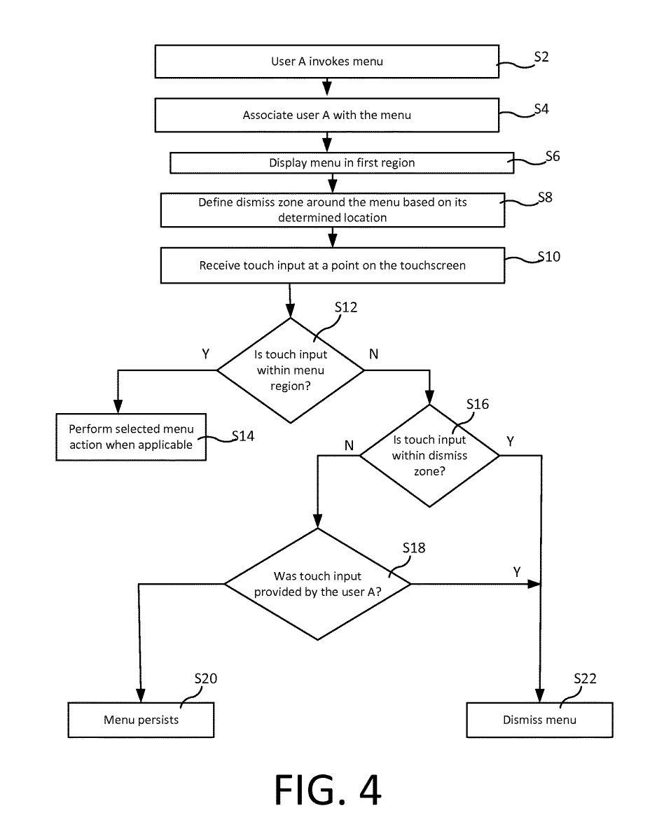

FIG. 4 shows a flow chart for a method, implemented by the application 20, which combines zone heuristics and skeletal tracking mechanisms.

A step S2, User A 10a invokes a menu, for example by selecting with a touch input a menu option displayed on the display 4 that is received by the application 20. In response, the application 20 identifies (S4) a first region of the total display area to be occupied (i.e. spanned) by the menu S4 when displayed. The first region has a size and location, which can be determined by the application 20 based on various factors, such as a current location and/or size of a main window of the application (particularly where the menu is displayed within the main window), default or user-applied settings stored in the memory 16 e.g. application-specific and/or general OS settings, the resolution and/or aspect ratio of display 4, the current state of any other application(s) currently being executed on the device 4. The first region is identified by generating display data for the menu—based on one or more of these factors—that defines the first region, for example as a set of coordinates corresponding to points of the total display area.

At step S4, the newly-invoked menu is associated with the user that invoked it i.e. User A, based on the skeletal tracking. In particular, the application 20 detects which of the users provided the input by analysing their skeletal movements (specifically the movements of the skeletons digits) at the time the user input was provided to invoke the menu, and associates that skeleton with the menu.

At step S6, the application 20 controls the display 4 to display the menu so that it occupies the first portion of the total display area.

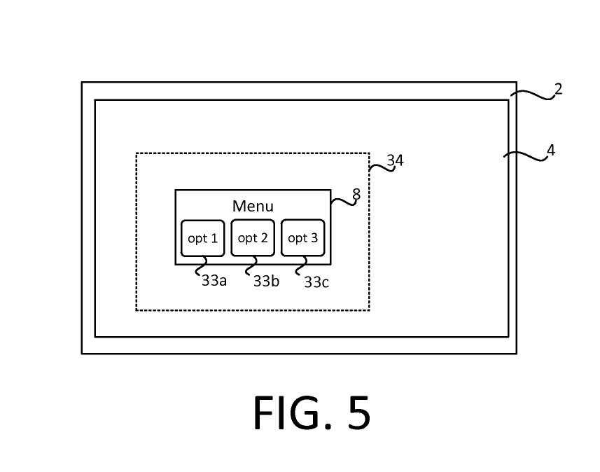

FIG. 5 shows the menu 8 displayed on the display 4. The displayed menu 8 comprises one or more options 33a, 33b, 33c that are selectable using a further touch input(s) to cause the display device 4 to perform an expected action associated with that option—such as placing a call to another user, initiating a whiteboard or screen sharing session with another user, adding one of the users' contacts to an existing communication event etc.

At step S8, the application 20 determines the location of the first region on the display 4 (i.e. its location within the total display area), and in some cases other characteristics of the first region such as its size, shape etc., in which the menu is displayed. The location is determined, for example, by accessing the display data generated at step S4.

In this example, each of the zones of FIG. 3A has a particular location and size. All of the zones have substantially the same size in the example of FIG. 3A. The location, size and shape of the menu are determined (at least approximately, and to a degree of accuracy acceptable in the present context) by determining which zone(s) the menu 8 spans.

The application 20 generates dismiss zone data that defines a dismiss zone for the menu 8. The dismiss zone is a second region 34 of the total display area surrounding the first region, but smaller than the total display area. The second region 34 has an outer boundary, shown as a dotted line in FIG. 5, that is determined based on the location of the first region spanned by the menu 8. The total area within the outer boundary of the dismiss zone 34, which is the area of the dismiss zone itself combined with the area of the first region occupied by the menu 8, is greater than the area of the first region (but still less than the total display area of the display 4). The second region 34 has a size and a location within the total display area that is dependent on the size and the location of the first region occupied by the menu 8.

In this example, the dismiss zone data identifies a plurality of the zones of FIG. 3A surrounding the first region in which the menu is displayed (e.g. zones 16, 17, 22, 26, 27 in the example of FIG. 3B; zones 1, 2, 7, 11 12, 16, 17, 21, 22, 26, 27 in the example of FIG. 6C), and is generated by selecting those zones based on the one or more zones spanned by the menu 8.

In defining the second region 34, the application 20 may determine whether the first region in which the menu 8 is displayed is near to the top of the display, by comparing its location with a height threshold, e.g. defining a particular row of the zones in FIG. 3A. In this case, the dismiss zone 34 is defined so as to span the entire height of the display as in FIG. 3C area only if, say, the display element is at or above the particular row.

Note, the ordering of steps S4 to S8 is immaterial, and some or all of these steps may be performed in parallel.

At step S10, one of the users 10a, 10b applies a touch input to a point on the touchscreen 4b. In response, the touchscreen 4b instigates an input signal to the application 20, which is received by the application 20 and conveys the location of the point on the screen, e.g. as (x,y) coordinates.

At step S12, the application 20 determines whether the point is within the menu region. If so, and if the input is within a region of the total display area spanned by one of the selectable options 33a, 33b, 33c, the application performs the expected action associated with that option.

If not, at step S16, the application 20 uses the dismiss zone data generated at step S8 to determine whether the touch input of step S10 is within the dismiss zone 34. If so, the application 20 controls the display 4 to dismiss (S22) the menu 34 i.e. so that it is no longer displayed (though a user may of course be able to cause it to be redisplayed by invoking it again).

If not, at step S18, the application 20 determines based on the skeletal tracking which of the users 10a, 10b provided the touch input at step S10 by analysing their movements (specifically the movements of the skeletons digits) at the time the input was provided. In particular, the application 20 determines whether the user that provided the touch input at step S16 is the user associated with the menu at step S6 i.e. User A. If so, the method proceeds to step S22, at which the menu is dismissed.

In other words, by tracking a skeleton's digits, a touch or mouse-click may be mapped against the skeleton that invoked them, and thereby determine which of the users 10a, 10b invoked the menu, affording the application 20 the ability to only dismiss a flyout if:
a touch-point occurs within a region in the immediate vicinity of a menu (but outside of its bounds) i.e. within the dismiss zone as defined above
a touch-point occurs outside the bounds of a menu in any zone, provided that the touch originates from the same skeleton that originally invoked the menu's display i.e. outside of the dismiss zone but by the user that originally invoked the menu

A fall-back mechanism can be used for instances where the originating skeleton becomes untrackable—such as a user sitting down or leaving the room. In the simplest case, this could be reverting to a system whereby the menu can only be dismissed if it is within the dismiss zone. An alternative is dismissing the menu in response to the originating skeleton becoming untrack able as in that case, it can be assumed that the user is no longer using the device, and that the menu is not relevant to the remaining user(s).

In the event that the touch input is outside of the dismiss zone 34 and provided by a different user (e.g. User B), the menu persists (S20) i.e. the menu S20 is substantially unaffected by the touch input provided at step S10.

A first aspect of the present subject matter is directed to a computer-implemented method of controlling a display of a display device that is useable by multiple users simultaneously, the display having a total display area, the method comprising: controlling the display to display a display element so that the display element occupies a first region of the total display area smaller than the total display area; determining a location of the first region of the total display area; based on the determined location of the first region, generating dismiss zone data so as to define a second region of the total display area that surrounds the first region, and that is smaller than the total display area; whilst the display element is being displayed on the display, receiving from one of the users of the media device via an input device of the media device a selection of a point on the display; and determining whether the point on the display selected by the user is outside of the first region but within the second region, and if so controlling the display to dismiss the display element.

In embodiments, the display element may comprise one or more selectable options displayed within the first region of the total display area, and the method may further comprise the step of: if the point on the display is within a region occupied by one of the selectable options, performing an expected action associated with that option.

The method may comprise generating zoning data so as to divide the total display area into a plurality of zones; wherein the location of the first region may be determined by identifying a first set of one or more of the zones spanned by the display element; and wherein the dismiss zone data may be generated by selecting a second set of one or more of the zones based on first set of zones, wherein the second set of zones surrounds the first set of zones.

For example, the method may comprise detecting a size and/or a pixel density of the display, and the zoning data may be generated based on the size and/or the pixel density of the display.

Alternatively or in addition, the input device may be a touchscreen of the display, the method may comprise detecting a touch resolution of the touchscreen, and the zoning data may be generated based on the touch resolution of the touchscreen.

The second region of the total display may be defined so that it spans the entire height of total display area.

For example, the method may comprise determining whether the first region is near the top of the display by comparing its determined location with a height threshold, and the second region may be defined so that it spans the entire height of the total display area if the first region is near the top of the display.

In some cases, the display element may not be dismissed if the point on the display selected by the user is outside of the second region.

The method may comprise associating one of the users with the display element, and determining whether the user that selected the point on the display is the user associated with the display element; the display element may be dismissed if the user that selected it is the user associated with the display element even if the point on the display is outside of the second region.

For example the user may be associated with the display element in response to that user causing the display element to be displayed using the or another input device of the display device.

Alternatively or in addition, the method may comprise applying a tracking algorithm to at least one moving image of the users, captured via at least one camera of the display device whilst the display element is being displayed on the display, to track movements of the users, and the tracked movements may be used to determine which of the users selected the point on the display.

For example, the tracking algorithm may be a skeletal tracking algorithm.

The method may comprise controlling the display to dismiss the display element in response to the tracking algorithm becoming unable to track the user associated with the display element.

The input device may be a touchscreen of the display.

According to a second aspect a display device is configured to be used by multiple users simultaneously and comprises: an output configured to connect to a display having a total display area; an input configured to connect to an input device; a processor; a memory configured to hold executable code, the code configured when executed to perform at least the following operations: controlling the display to display a display element so that the display element occupies a first region of the total display area smaller than the total display area; determining a location of the first region of the total display area; based on the determined location of the first region, generating dismiss zone data so as to define a second region of the total display area that surrounds the first region, and that is smaller than the total display area; whilst the display element is being displayed on the display, receiving from one of the users of the media device via the input device a selection of a point on the display; and determining whether the point on the display selected by the user is outside of the first region but within the second region, and if so controlling the display to dismiss the display element.

In embodiments, the display may be integrated in the display device.

The input device may be a touchscreen of the display.

The display device may be arranged to be mounted on a wall.

A third aspect is directed to a computer-implemented method of controlling a display of a display device that is useable by multiple users simultaneously, the display having a total display area, the method comprising: controlling the display to display a display element so that the display element occupies a region of the total display area smaller than the total display area; associating one of the users of the display device with the display element; using at least one camera of the display device to capture a moving image of the users whilst the display element is being displayed on the display; whilst the display element is being displayed on the display, detecting a touch input at a point on a touchscreen of the display; using the moving image of the users to determine whether the touch input was provided by the user associated with the display element; and controlling the display to dismiss the display element if: (i) the touch input was provided by the user associated with the display element, and (ii) the point on the touchscreen is outside of the region of the display area occupied by the display element.

In embodiments, the method may comprise applying a tracking algorithm to the moving image of the users whilst the display element is being displayed on the display, to track movements of the users, and the tracked movements may be used to determine whether the touch input was provided by the user associated with the display element.

For example, the tracking algorithm may be a skeletal tracking algorithm.

Alternatively or in addition the method may comprise controlling the display to dismiss the display element in response to the tracking algorithm becoming unable to track the user associated with the display element.

Alternatively or in addition the method may comprise: generating dismiss zone data so as to define another region of the total display area that surrounds the region occupied by the display element, and that is smaller than the total display area; wherein if the tracking algorithm becomes unable to track the user associated with the display element, so that there is no longer any tracked user associated with the display element, the display element may be able to be dismissed by any user selecting a point on the touchscreen that is outside of the region occupied by the display element but within the other region surrounding it.

The user may be associated with the display element in response to that user causing the display element to be displayed using the touchscreen or another input device of the display device.

The display element may comprise one or more selectable options displayed within the region of the total display area occupied by the display element, and the method may further comprise the step of: if the point on the touchscreen is within a respective region occupied by one of the one or more selectable options, performing an expected action associated with that option.

For example, the respective region occupied each of the one or more selectable options may be a sub region of the region occupied by the display element, smaller than that region. Alternatively the display element may be a single selectable option, which occupies all of said region.

The method may comprise: generating dismiss zone data so as to define another region of the total display area that surrounds the region occupied by the display element, and that is smaller than the total display area; and controlling the display to dismiss the display element if: (i) the touch input was provided by another of the users not associated with the display element, and (ii) the point on the touchscreen is outside of the region but within the other region, whereby the display element is not dismissed if the touch input is outside of the other region and provided by the other user.

The display element may be dismissed if the point on the touchscreen is outside of the other region provided the touch input is provided by the user associated with the display element.

The method may comprise detecting a size and/or a pixel density of the display and/or a touch resolution of the touchscreen, wherein the dismiss zone data is generated based on the size and/or the pixel density and/or the touch resolution.

The second region of the total display may span the entire height of total display area.

The method may comprise determining whether the region occupied by the display element is near the top of the display by comparing its location with a height threshold, wherein the other region surrounding it may be defined so that it spans the entire height of the total display area if the region occupied by the display element is near the top of the display.

According to a fourth aspect present subject matter a display device is configured to be used by multiple users simultaneously and comprises: an output configured to connect to a display having a total display area; an input configured to connect to a touchscreen of the display; a processor; a memory configured to hold executable code, the code configured when executed to perform at least the following operations: controlling the display to display a display element so that the display element occupies a region of the total display area smaller than the total display area; associating one of the users of the display device with the display element in the memory; using at least one camera of the display device to capture a moving image of the users whilst the display element is being displayed on the display; whilst the display element is being displayed on the display, detecting a touch input at a point on the touchscreen of the display; using the moving image of the users to determine whether the touch input was provided by the user associated with the display element; and controlling the display to dismiss the display element if: (i) the touch input was provided by the user associated with the display element, and (ii) the point on the touchscreen is outside of the region of the display area occupied by the display element.

Note any the features implemented in embodiments of any of the above aspects may likewise be implemented in embodiments of any of the other aspects.

According to a fifth aspect of the present subject matter a computer program product comprises executable code stored on a computer readable storage medium, the code for controlling a display of a display device that is useable by multiple users, the display having a total display area, wherein the code is configured when executed on the processor to perform at least the following operations to implement any of the method steps or device functionality disclosed herein.

In embodiments, the code may be a communication client for effecting a communication events between the users of the display device and at least another user via a communications network.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors. For example, the display device may also include an entity (e.g. software) that causes hardware of the device to perform operations, e.g., processors functional blocks, and so on. For example, the display device may include a computer-readable medium that may be configured to maintain instructions that cause the devices, and more particularly the operating system and associated hardware of the devices to perform operations. Thus, the instructions function to configure the operating system and associated hardware to perform the operations and in this way result in transformation of the operating system and associated hardware to perform functions. The instructions may be provided by the computer-readable medium to the display device through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method of controlling a display of a display device that is useable by multiple users simultaneously, the display having a total display area, the method comprising:
controlling the display to display a display element so that the display element occupies a first region of the total display area smaller than the total display area;
determining a location of the first region of the total display area;
based on the determined location of the first region, generating dismiss zone data so as to define a second region of the total display area that surrounds the first region, and that is smaller than the total display area;
whilst the display element is being displayed on the display, receiving from one of the users of the media device via an input device of the media device a selection of a point on the display; and
determining whether the point on the display selected by the user is outside of the first region but within the second region, and if so controlling the display to dismiss the display element.

2. A method according to claim 1, wherein the display element comprises one or more selectable options displayed within the first region of the total display area, and the method further comprises the step of:
if the point on the display is within a region occupied by one of the selectable options, performing an expected action associated with that option.

3. A method according to claim 1, comprising generating zoning data so as to divide the total display area into a plurality of zones;
wherein the location of the first region is determined by identifying a first set of one or more of the zones spanned by the display element; and
wherein the dismiss zone data is generated by selecting a second set of one or more of the zones based on first set of zones, wherein the second set of zones surrounds the first set of zones.

4. A method according to claim 3, comprising detecting a size and/or a pixel density of the display, wherein the zoning data is generated based on the size and/or the pixel density of the display.

5. A method according to claim 3, wherein the input device is a touchscreen of the display, the method comprising detecting a touch resolution of the touchscreen, wherein the zoning data is generated based on the touch resolution of the touchscreen.

6. A method according to claim 1, wherein the second region of the total display is defined so that it spans the entire height of total display area.

7. A method according to claim 1, comprising determining whether the first region is near the top of the display by comparing its determined location with a height threshold, wherein the second region is defined so that it spans the entire height of the total display area if the first region is near the top of the display.

8. A method according to claim 1, wherein the display element is not dismissed if the point on the display selected by the user is outside of the second region.

9. A method according to claim 1, comprising associating one of the users with the display element, and determining whether the user that selected the point on the display is the user associated with the display element;
wherein display element is dismissed if the user that selected it is the user associated with the display element even if the point on the display is outside of the second region.

10. A method according to claim 9, wherein the user is associated with the display element in response to that user causing the display element to be displayed using the another input device of the display device.

11. A method according to claim 9, comprising applying a tracking algorithm to at least one moving image of the users, captured via at least one camera of the display device whilst the display element is being displayed on the display, to track movements of the users, the tracked movements being used to determine which of the users selected the point on the display.

12. A method according to claim 11, wherein the tracking algorithm is a skeletal tracking algorithm.

13. A method according to claim 11, comprising controlling the display to dismiss the display element in response to the tracking algorithm becoming unable to track the user associated with the display element.

14. A method according to claim 1, wherein the input device is a touchscreen of the display.

15. A display device configured to be used by multiple users simultaneously, the display device comprising:
an output configured to connect to a display having a total display area;
an input configured to connect to an input device;
a processor;
a memory configured to hold executable code, the code configured when executed to perform at least the following operations:
controlling the display to display a display element so that the display element occupies a first region of the total display area smaller than the total display area;
determining a location of the first region of the total display area;
based on the determined location of the first region, generating dismiss zone data so as to define a second region of the total display area that surrounds the first region, and that is smaller than the total display area;
whilst the display element is being displayed on the display, receiving from one of the users of the media device via the input device a selection of a point on the display; and
determining whether the point on the display selected by the user is outside of the first region but within the second region, and if so controlling the display to dismiss the display element.

16. A display device according to claim 15, wherein the display is integrated in the display device.

17. A display device according to claim 15, wherein the input device is a touchscreen of the display.

18. A display device according to claim 15, which is arranged to be mounted on a wall.

19. A computer program product comprising executable code stored on a computer readable storage medium, the code for controlling a display of a display device that is useable by multiple users, the display having a total display area, wherein the code is configured when executed on the processor to perform at least the following operations:
controlling the display to display a display element so that the display element occupies a first region of a total display area smaller than the total display area;
determining a size location of the first region of the total display;
based on the determined location of the first region, generating dismiss zone data so as to define a second region of the total display area that surrounds the first region, and that is smaller than the total display area;
whilst the display element is being displayed on the display, receiving from one of the users of the media device via an input device of the media device a selection of a point on the display; and
determining whether the point on the display selected by the user is outside of the first region but within the second region, and if so controlling the display to dismiss the display element.

20. A computer program product according to claim 19, wherein the code is a communication client for effecting a communication events between the users of the display device and at least another user via a communications network.
